(19) United States
(12) Patent Application Publication
(10) Pub. No.: US 2002/0139207 A1
(43) Pub. Date: Oct. 3, 2002

(54) Rack with integral piston for hydraulic power assist rack and pinion steering system

(75) Inventors: Richard A. Stoll, Royal Oak, MI (US); John S. Borza, Shelby Township, MI (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Inc.

(21) Appl. No.: 09/819,432

(22) Filed: Mar. 28, 2001

(51) Int. Cl. F16H 1/04; F16H 21/44; F16H 21/54; F16H 25/18; B62D 5/06

(52) U.S. Cl. 74/422; 74/388 PS; 180/417; 180/428; 74/96

(57) ABSTRACT

A hydraulic power assist rack and pinion steering system (12) for a vehicle includes a housing (14) in which a rack (10) is movable along an axis (16) to effect turning movement of steerable wheels of the vehicle. The rack (10) comprises a first rack part (50) having an elongate body portion (56) and an end portion formed as a first piston portion (58), and a second rack (80) part having an elongate body portion (86) and an end portion formed as a second piston portion (88). The first piston portion (58) of the first rack part (50) is joined to the second piston portion (88) of the second rack part (80) to form a piston (22). The body portion (56) of the first rack part (50) extends axially away from the piston (22) in a first direction (110). The body portion (86) of the second rack part (80) extends axially away from the piston (22) in a second direction (112) opposite the first direction (110).

### BACKGROUND OF THE INVENTION

1. Technical Field

The present invention relates to a rack for a hydraulic power assist rack and pinion steering system.

2. Description of the Prior Art

U.S. Pat. No. 5,890,394 describes a hydraulic power assist rack and pinion steering system for a vehicle. The system includes a rack movable to effect turning movement of steerable wheels of the vehicle. Flexible boots are mounted on each end of the rack. A breather hole extending longitudinally through the rack allows the boots to communicate with each other to maintain pressure equilibrium so that neither boot collapses or is subjected to excessive expansion.

### SUMMARY OF THE INVENTION

The present invention is a rack for a hydraulic power assist rack and pinion steering system for a vehicle having steerable wheels. The system includes a housing in which the rack is movable along an axis to effect turning movement of the steerable wheels of the vehicle. The rack comprises a first rack part having an elongate body portion and an end portion formed as a first piston portion, and a second rack part having an elongate body portion and an end portion formed as a second piston portion. The first piston portion of the first rack part is joined to the second piston portion of the second rack part to form a piston. The body portion of the first rack part extends axially away from the piston in a first direction. The body portion of the second rack part extends axially away from the piston in a second direction opposite the first direction.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is an elevational view, partly in section, of a hydraulic power assist rack and pinion steering system including a rack and piston in accordance with a first embodiment of the present invention;

FIG. 2 is an enlarged view of a portion of FIG. 1 showing the piston;

FIG. 3 is a view of a rack formed in accordance with a second embodiment of the invention; and

FIG. 4 is a schematic illustration of a process of forming the rack of FIG. 3.

### DETAILED DESCRIPTION OF THE INVENTION

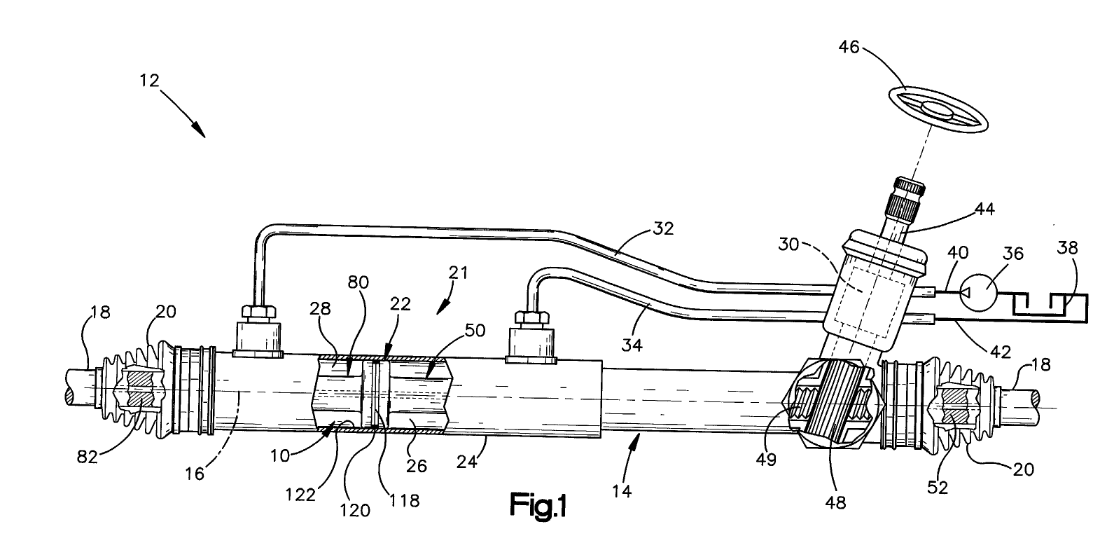

The present invention relates to a rack for a hydraulic power assist rack and pinion steering system. The present invention is applicable to various rack designs for hydraulic power assist rack and pinion steering systems. As representative of the present invention, FIG. 1 illustrates a rack 10, which forms a part of a steering system 12.

The steering system 12 includes a housing 14. The rack 10, described below in detail, is supported by and is movable relative to the housing 14 along an axis 16. Opposite ends of the rack 10 are connected by suitable linkage 18, such as tie rods, with steerable wheels (not shown) of the vehicle. At opposite ends of the rack 10, two flexible boots 20 seal the connections between the rack and the steering linkage 18. Upon axial movement of the rack 10 relative to the housing 14, the steerable wheels of the vehicle are turned in a known manner.

The steering system 12 includes a hydraulic motor 21 for assisting the vehicle operator in turning the steerable wheels of the vehicle. The hydraulic motor 21 includes a piston 22, which is formed as part of the rack 10 in a manner described below. The piston 22 is disposed in a cylinder 24 formed by the housing 14. The piston 22 divides the cylinder 24 into first and second fluid chambers or pressure chambers 26 and 28.

A control valve 30 is disposed in the housing 14. The control valve 30 is connected with the first and second chambers 26 and 28 of the motor 20 by a pair of conduits 32 and 34. The control valve 30 is also connected with a pump 36 and with a reservoir or sump 38, by another pair of conduits 40 and 42.

The steering system 12 further includes an input shaft 44. The input shaft 44 is connected for rotation with a steering wheel 46 of the vehicle. A torsion bar (not shown) in the control valve 30 connects the input shaft 44 with a pinion 48. The pinion 48 is in meshing engagement with the rack 16.

Upon rotation of the vehicle steering wheel 46, the torsion bar twists to enable the input shaft 44 to rotate relative to the pinion 48. Upon such relative rotation, the control valve 30 directs hydraulic fluid under pressure from the pump 36 to the motor 20. Operation of the hydraulic motor 20 moves the rack 16 and drives the pinion 48 to rotate in a follow-up manner. The control valve 30 returns to a neutral condition when the steerable wheels of the vehicle have been turned to an extent corresponding to rotation of the steering wheel 46 and the input shaft 44.

The rack 10 is formed from first and second rack parts 50 and 80 joined to each other in a manner as described below. The first rack part 50 is preferably formed as one piece, from a suitable material, such as carbon steel. The first rack part 50 may be deep drawn to the configuration shown, or could be formed in ay other suitable manner.

The first rack part 50 has an elongate configuration including a first end portion 52 and a second end portion 54. The first rack part 50 includes a body portion 56 and a piston portion 58.

The body portion 56 of the first rack part 50 has an elongate, cylindrical configuration centered on the axis 16. The body portion 56 has a cylindrical outer surface 60. The body portion 56 of the first rack part 50 terminates in the first end portion 52 of the first rack part.

The piston portion 58 forms the second end portion 54 of the first rack part 50. The piston portion 58 of the first rack part 50 is formed as a flange 62 extending radially outward from the cylindrical outer surface 60 of the body portion 56 of the first rack part. The flange 62 has a disk-like configuration including a circular first end surface 64 and an annular second end surface 66. The flange 62 has a cylindrical outer side surface 68. A frustoconical chamfer 70 extends between the outer side surface 68 and the first end surface 64.

An internal opening 72 extends for the entire length of the first rack part 50, between the first end portion 52 of the first rack part and the first end surface 64 of the piston portion 58 of the first rack part. In the illustrated embodiment, the opening 72 has a cylindrical configuration centered on the axis 16. The opening 72 serves as a breather hole that establishes fluid communication between the first end portion 52 and the second end portion 54 of the first rack part 50.

The second rack part 80 is similar in construction to the first rack part 50, the only significant difference being the length of the body portion. The second rack part 80 may be formed in the same manner as the first rack part 50.

The second rack part 80 has an elongate configuration including a first end portion 82 and a second end portion 84. The second rack part 80 includes a body portion 86 and a piston portion 88.

The body portion 86 of the second rack part 80 has an elongate, cylindrical configuration centered on the axis 16. The body portion 86 has a cylindrical outer surface 90. The body portion 86 of the second rack part 80 terminates in the first end portion 82 of the second rack part.

The piston portion 88 forms the second end portion 84 of the second rack part 80. The piston portion 88 of the second rack part 80 is formed as a flange 92 extending radially outward from the cylindrical outer surface 90 of the body portion 86 of the second rack part. The flange 92 has a disk-like configuration including a circular first end surface 94 and an annular second end surface 96. The flange 92 has a cylindrical outer side surface 98. A frustoconical chamfer 100 extends between the outer side surface 98 and the first end surface 94.

An internal opening 102 extends for the entire length of the second rack part 80, between the first end portion 82 of the second rack part and the first end surface 94 of the piston portion 88 of the second rack part. In the illustrated embodiment, the opening 102 has a cylindrical configuration centered on the axis 16. The opening 102 serves as a breather hole that establishes fluid communication between the first end portion 82 and the second end portion 84 of the second rack part 80.

The first rack part 50 is joined to the second rack part 80 to form the rack 10. This joining can be done in several different manners. One method is described below.

The piston portion 58 of the first rack part 50 is spin welded to the piston portion 88 of the second rack part 80. The rack parts 50 and 80 may be piloted together to keep them in alignment. The first end surface 64 of the piston portion 58 of the first rack part 50 is in abutting engagement with the first end surface 94 of the piston portion 88 of the second rack part 80. The joined piston portions 58 and 88 form the piston 22.

The body portion 56 of the first rack part 50 extends axially away from the piston 22 in a first directions indicated by the arrow 110. The body portion 86 of the second rack part 80 extends axially away from the piston 22 in a second direction as indicated by the arrow 112 opposite the first direction 110. The body portion 86 of the second rack part 80 is coaxial with the body portion 56 of the first rack part 50. The breather hole 72 in the first rack part 50 aligns with the breather hole 102 in the second rack part 80 to form a breather passage 114 extending completely through the rack 10.

The chamfers 70 and 100 adjoin to form a V-shaped groove 116 in the piston 22. The groove 116, after the spin welding process, may be at least partially filled with weld material. The outer side surface of the piston 22 is machined out to form an outer peripheral groove 118 (FIG. 1). A seal ring 120 is received in the outer peripheral groove 118 of the piston 22. The seal 120 is in sealing engagement with a cylindrical inner surface 122 of the housing 14.

When the rack, including the piston, is assembled in the housing 14, the piston is located between and partially defines the first and second pressure chambers 26 and 28 in the housing. The second end surface 66 of the piston portion 58 of the first rack part 50 forms a first end face of the piston 22. The second end face 66 is exposed to pressurized fluid in the first pressure chamber 26. The second end surface 96 of the piston portion 88 of the second rack part 80 forms a second end face of the piston 22. The second end face 96 is exposed to pressurized fluid in the second pressure chamber 28.

In operation of the steering system 12, hydraulic fluid is directed by the pump 36, in a known manner, against the first and second end faces 66 and 96 of the piston 22, to effect movement of the piston, and thereby the rack 10, relative to the housing 14. The seal 120 seals against the cylindrical inner surface 122 of the housing 14.

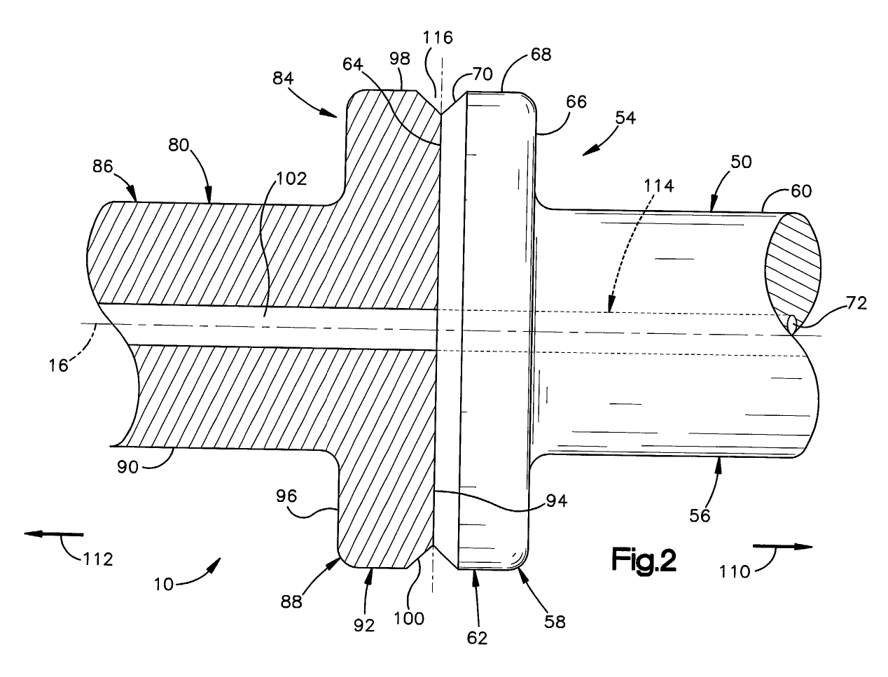

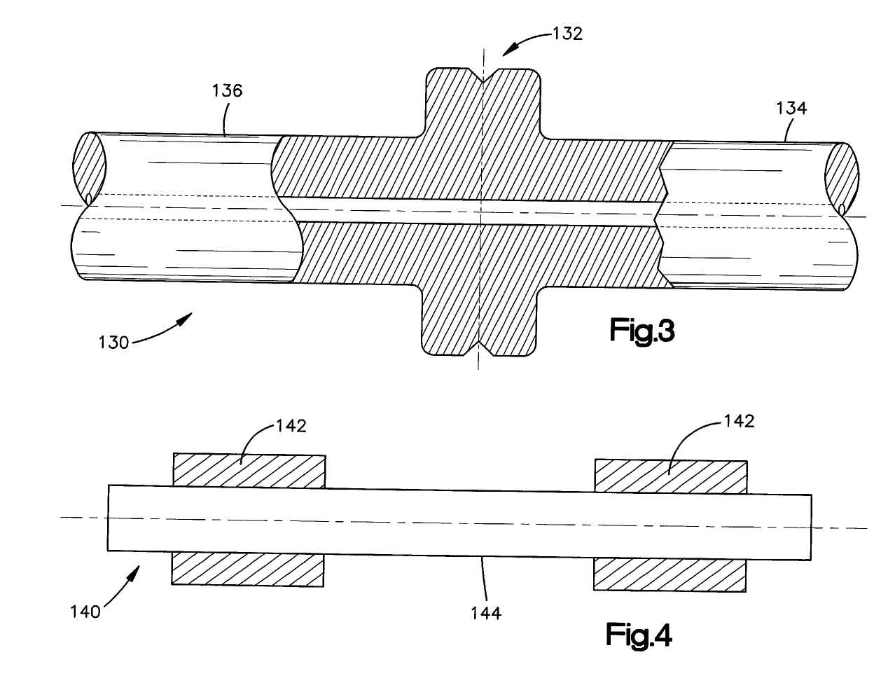

FIG. 3 illustrates a rack 130 formed in accordance with a second embodiment of the invention. The rack 130 is similar in configuration to the rack 10 (FIGS. 1-3), but is made from a single piece of material, such as steel.

The rack 130 has a piston portion 132 intermediate first and second body portions 134 and 136. The first body portion 134 extends axially from the piston portion 132 in a first direction, that is, to the right as viewed in FIG. 3. The second body portion 136 extends axially from the piston portion 132 in a second direction opposite the first direction, that is, to the left as viewed in FIG. 3.

The rack 130 is formed by taking a single piece (a blank) of suitable material, such as steel, as illustrated schematically at 140 in FIG. 4. The blank 140 may be solid or hollow. Two gripping sleeves shown schematically at 142 are brought into engagement with the blank 140, gripping it at axially spaced locations, leaving a center portion 144 uncovered. This uncovered central portion 144 is where the piston portion 132 is to be formed.

The uncovered central portion 144 of the blank 140 is then heated, bringing it to a temperature at which it will deform readily when subjected to force. The gripping sleeves 142 are then moved axially toward each other, applying a compressive force to the central portion 144 of the blank 140. This compressive force causes the central portion 144 of the blank 140 to bulge radially outwardly, forming a larger diameter portion of the blank. This larger diameter portion becomes the piston portion 132 of the rack 130. If desired, at the same time as the axial compressive force is being applied, the blank 140 may be spun rapidly about its axis, to assist in the radially outward flow of material.

Once the blank 140 is thus formed, it can then be machined in one operation to form the piston portion 132 and the first and second body portions 134 and 136 of the rack 130. The piston portion 132 can have a peripheral groove for receiving a seal ring for engagement with the housing.

From the foregoing description of the invention, those skilled in the art will perceive improvements, changes and modifications in the invention. For example, the two piston portions 58 and 88 might have different axial lengths, and the weld joining them would not be in the center of the piston 22. The seal ring groove 118 would be machined at a location other than the weld. Such improvements, changes and modifications within the skill of the art are intended to be covered by the appended claims.

Having described the invention, we claim:

1. A rack for a hydraulic power assist rack and pinion steering system for a vehicle having steerable wheels, the system including a housing in which said rack is movable along an axis to effect turning movement of the steerable wheels of the vehicle, said rack comprising:
a first rack part having an elongate body portion and an end portion formed as a first piston portion; and
a second rack part having an elongate body portion and an end portion formed as a second piston portion;
said first piston portion of said first rack part being joined to said second piston portion of said second rack part to form a piston;
said body portion of said first rack part extending axially away from said piston in a first direction;
said body portion of said second rack part extending axially away from said piston in a second direction opposite said first direction.

2. A rack as set forth in claim 1 wherein said piston has first and second opposite end faces against which hydraulic fluid is directed to effect movement of said piston, and thereby said rack, relative to said housing, said first end face being formed on said first rack part and said second end face being formed on said second rack part.

3. A rack as set forth in claim 1 wherein said piston has an outer peripheral groove for receiving a seal ring for engagement with said housing, said outer peripheral groove being formed between said first rack part and said second rack part.

4. A rack as set forth in claim 1 wherein said piston portion of said first rack part has the same axial length as said piston portion of said second rack part.

5. A rack as set forth in claim 1 wherein said body portion of said first rack part is coaxial with said body portion of said second rack part.

6. A rack as set forth in claim 1 wherein at least a portion of said body portion of said first rack part has a smaller diameter than said piston portion of said first rack part.

7. A rack as set forth in claim 1 wherein each one of said piston portions has a respective chamfer, said chamfers adjoining when said first rack part is secured to said second rack part.

8. A rack as set forth in claim 1 wherein said first rack part is joined to said second rack part by spin welding.

9. A rack as set forth in claim 1 having a seal ring groove formed in said piston after said first rack part is joined to said second rack part.

10. A rack for a hydraulic power assist rack and pinion steering system for a vehicle having steerable wheels, the system including a housing in which said rack is movable along an axis to effect turning movement of the steerable wheels of the vehicle, said rack comprising:
a cylindrical member having a cylindrical piston portion intermediate cylindrical first and second body portions;
said first body portion of said member extending axially away from said piston portion in a first direction;
said second body portion of said member extending axially away from said piston portion in a second direction opposite said first direction;
said first body portion and said second body portion and said piston portion being formed as one piece with each other from a single piece of material, such as steel;
said first body portion and said second body portion having a first diameter, said piston portion having a second diameter that is greater than said first diameter.

11. A rack as set forth in claim 10 wherein said piston portion has a peripheral groove for receiving a seal ring for engagement with said housing.

12. A rack as set forth in claim 10 wherein said cylindrical member is hollow through said first body portion and said second body portion and said piston portion.

13. A rack as set forth in claim 10 wherein said cylindrical member is solid through said first body portion and said second body portion and said piston portion.

14. A rack as set forth in claim 10 wherein said rack is formed by compressing said cylindrical member axially to make said piston portion larger in diameter than said first and second body portions.
